(19) United States
(12) Patent Application Publication
(10) Pub. No.: US 2002/0188726 A1
(43) Pub. Date: Dec. 12, 2002

(54) Data object mark and send procedure

(76) Inventors: Andrew N. Schick, Lawrenceville, GA (US); Michael F. Boucher, Dacula, GA (US)

Correspondence Address: MATSUSHITA MOBILE COMMUNICATIONS, DEVELOPMENT CORPORATION OF USA, 1225 NORTHBROOK PARKWAY, SUWANEE, GA, 30024, US

(21) Appl. No.: 09/876,911

(22) Filed: Jun. 8, 2001

(51) Int. Cl. G06F 15/16

(52) U.S. Cl. 709/227

(57) ABSTRACT

A method of marking data objects on a communication device for transfer is disclosed which involves presenting a data object on the user interface of an electronic device (402). After a data object is presented on the user interface (402), the present invention determines if the data object is capable of transfer to another communication device (404). This determination involves applying a set of criteria to the data object to determine if the electronic device can provide for the transfer, considering the attributes of the data object such as size and file type. If the data object is such that it can be transferred, a transfer enable indicator is presented on the display of the electronic device (406). The user can mark a data object for transfer when the transfer enable indicator is presented on the user interface (408).

### FIELD OF THE INVENTION

This invention relates generally to the field of communication technology, and in particular, to methods of transferring data objects from one communication device to another communication device.

### BACKGROUND OF THE INVENTION

People rely on various portable communication devices, such as cellular telephones, personal data assistants, and other portable electronic devices to communicate every day. As memory sizes increase and as the use of electronic data objects increases, these portable communication devices become a repository for such electronic objects. Because of the situations in which these technologies are used, and the importance such technologies have in everyday life, many times users may need to communicate this data objects, such as text messages, voice memos, and various files downloaded from the Internet, between communication devices. However, many times the user does not know if the data object is capable of transfer to another communication device, possibly due to memory or file size limitations. Furthermore, if the data object can be transferred, the user may want to simply mark one or more data objects for transfer later, rather than immediately transferring these data objects. Thus, there is a need to improve upon the user interface for data objects between various communication technologies.

Current technology does not adequately provide an indication to the user when a data object is capable of transfer, and does not adequately provide for marking these data objects for communication to another electronic device. However, implementing such a procedure for a communication device presents several complicated issues. The implementation should be able to: 1) differentiate between data objects which can be transferred to another electronic device verses those that cannot; 2) provide an indication that the data object is capable of transfer to another electronic device; and 3) provide an indication when a data object is marked for transfer to another electronic device.

In view of the foregoing, a data object marking feature for a communication device must be able to analyze a data object to determine its size and other characteristics, provide either an auditory, visual, or silent indication when the data object can be transferred, and indicate by either an auditory, visual, or silent indication that the user has marked a particular data object for transfer to another communication device. There is a need for this feature because such would increase the ease of transferring such data objects between communication devices, as well as improve the user interface involved in such a task, which will become increasingly necessary as the dependence on these technologies grows.

### SUMMARY OF THE INVENTION

The present invention satisfies the above needs by providing a system and method to identify objects capable of transfer to another communication device, mark an object for transfer to another communication device, and identify objects that have been marked. When a data object is presented on the user interface, the communication device determines if the data object is capable of transfer. If so, a transfer capability indicator, such as an icon, lit pixel, or other form of indication, is presented on the user interface. The transfer enable indicator could even be silence, for example, in a communication device which provides an indication only when a selected data object is incapable of transfer. If the transfer enable indicator is active when a data object is present on the user interface, the user can mark the data object for transfer. Once the data object is marked, a marked object indicator is associated with the data object to signify that the object has been marked for transfer. This step may involve presenting an marked icon with the data object on the user interface of the device, or may simply be a flag associated with the data object which is set in memory when the data object is marked. Once marked, the device can send the marked object, along with any other marked objects, either automatically or at the user's request. In one embodiment, the send operation may form a list of marked data objects which the user may edit before completion of the send operation. These and other aspects, features, and advantages of the present invention will be more clearly understood and appreciated from a review of the following detailed description of the present invention and possible embodiments thereof, and by reference to the appended drawings and claims.

### BRIEF DESCRIPTION OF THE DRAWINGS

FIG. 1 is a system diagram that illustrates an exemplary environment suitable for implementing various embodiments of the present invention.

FIG. 2 is a simplified system diagram illustrating the functional components within an exemplary embodiment of the present invention.

FIG. 3 is an illustration representing an exemplary display of a communication device embodying the present invention.

FIG. 4 is a flow diagram illustrating the steps involved in an exemplary embodiment of the data object mark and send operation of the present invention.

FIG. 5 is a flow diagram illustrating the steps involved in an exemplary embodiment of the data object mark and send operation of the present invention involving multiple marked data objects.

FIG. 6 is an illustration representing an exemplary display of the communication device embodying the present invention once a data object has been marked for transfer.

### DETAILED DESCRIPTION OF THE PREFERRED EMBODIMENT

Referring now to the figures in which like numerals refer to like elements throughout the several views, various embodiments and aspects of the present invention are described. Although the present invention is described as embodied within a communication device such as a cellular telephone, those skilled in the art will appreciate that the present invention may be used in conjunction with any electronic device used for communicating with one or more electronic devices, or any other communication device which has the capability to transfer data objects.

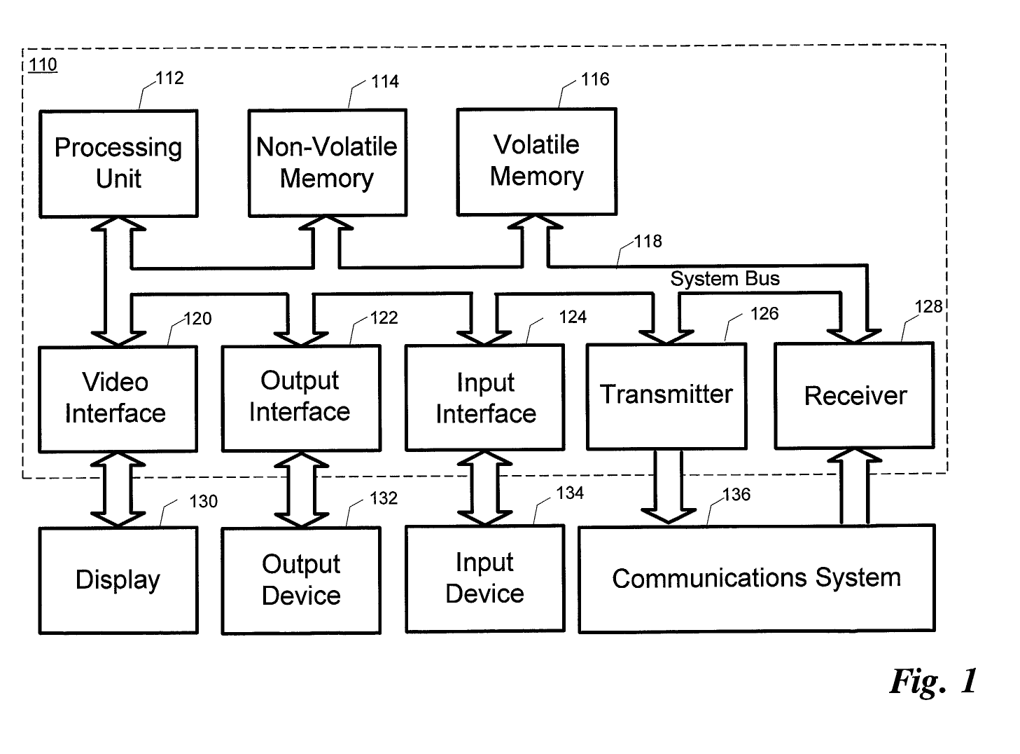

FIG. 1 is a system diagram that illustrates an exemplary environment suitable for implementing various embodiments of the present invention. FIG. 1 and the following discussion provide a general overview of a platform onto which the invention may be integrated or implemented. Although in the context of the exemplary environment the invention will be described as consisting of instructions within a software program being executed by a processing unit, those skilled in the art will understand that portions of the invention, or the entire invention itself may also be implemented by using hardware components, state machines, or a combination of any of these techniques. In addition, a software program implementing an embodiment of the invention may run as a stand-alone program or as a software module, routine, or function call, operating in conjunction with an operating system, another program, system call, interrupt routine, library routine, or the like. The term program module will be used to refer to software programs, routines, functions, macros, data, data structures, or any set of machine readable instructions or object code, or software instructions that can be compiled into such, and executed by a processing unit.

Those skilled in the art will appreciate that the system illustrated in FIG. 1 may take on many forms and may be directed towards performing a variety of functions. Examples of such forms and functions include mainframe computers, mini computers, servers, work stations, personal computers, hand-held devices such a personal data assistants and calculators, consumer electronics, note-book computers, lap-top computers, and a variety of other applications, each of which may serve as an exemplary environment for embodiments of the present invention. The invention may also be practiced in a distributed computing environment where tasks are performed by remote processing devices that are linked through a communications network. In a distributed computing environment, program modules may be located in both local and remote memory storage devices.

The exemplary system illustrated in FIG. 1 includes a computing device 110 that is made up of various components including, but not limited to a processing unit 112, nonvolatile memory 114, volatile memory 116, and a system bus 118 that couples the nonvolatile memory 114 and volatile memory 116 to the processing unit 112. The non-volatile memory 114 may include a variety of memory types including, but not limited to, read only memory (ROM), electronically erasable read only memory (EEROM), electronically erasable and programmable read only memory (EEPROM), electronically programmable read only memory (EPROM), electronically alterable read only memory (EAROM), and battery backed random access memory (RAM). The non-volatile memory 114 provides storage for power on and reset routines (bootstrap routines) that are invoked upon applying power or resetting the computing device 110. In some configurations the non-volatile memory 114 provides the basic input/output system (BIOS) routines that are utilized to perform the transfer of information between elements within the various components of the computing device 110.

The volatile memory 116 may include, but is not limited to, a variety of memory types and devices including, but not limited to, random access memory (RAM), dynamic 5 random access memory (DRAM), FLASH memory, EEROM, bubble memory, registers, or the like. The volatile memory 116 provides temporary storage for routines, modules, functions, macros, data etc. that are being or may be executed by, or are being accessed or modified by the processing unit 112. In general, the distinction between non-volatile memory 114 and volatile memory 116 is that when power is removed from the computing device 110 and then reapplied, the contents of the non-volatile memory 114 remain intact, whereas the contents of the volatile memory 116 may be lost, corrupted, or erased.

The computing device 110 may access one or more external display devices 130 such as a CRT monitor, LCD panel, LED panel, electro-luminescent panel, or other display device, for the purpose of providing information or computing results to a user. The processing unit 112 interfaces to each display device 130 through a video interface 120 coupled to the processing unit 112 over system bus 118.

The computing device 110 may receive input or commands from one or more input devices 134 such as a keyboard, pointing device, mouse, modem, RF or infrared receiver, microphone, joystick, track ball, light pen, game pad, scanner, camera, or the like. The processing unit 112 interfaces to each input device 134 through an input interface 124 coupled to the processing unit 112 over system bus 118. The input interface may include one or more of a variety of interfaces, including but not limited to, an RS-232 serial port interface or other serial port interface, a parallel port interface, a universal serial bus (USB), an optical interface such as infrared or IRDA, an RF or wireless interface such as Bluetooth, or other interface.

The computing device 110 may send output information, in addition to the display 130, to one or more output devices 132 such as a speaker, modem, printer, plotter, facsimile machine, RF or infrared transmitter, or any other of a variety of devices that can be controlled by the computing device 110. The processing unit 112 interfaces to each output device 132 through an output interface 122 coupled to the processing unit 112 over system bus 118. The output interface may include one or more of a variety of interfaces, including but not limited to, an RS-232 serial port interface or other serial port interface, a parallel port interface, a universal serial bus (USB), an optical interface such as infrared or IRDA, an RF or wireless interface such as Bluetooth, or other interface.

The computing device 110 may exchange information through a communications system 136. The computing device 110 transmits information to the communication system 136 through transmitter 126. The computing device 110 receives information from the communications system 136 through a receiver 128. The processing unit 112 interfaces with the communications system 136 through the transceiver 126 and the receiver 128, which are both coupled to the processing unit 112 over system bus 118.

It will be appreciated that program modules implementing various embodiments of the present invention may be stored in the non-volatile memory 114 or the volatile memory 116. The program modules may include an operating system, application programs, other program modules, and program data. The processing unit 112 may access various portions of the program modules in response to the various instructions contained therein, as well as under the direction of events occurring or being received over the input interface 124.

In the exemplary embodiment, the environment of FIG. 1 has an LCD display coupled to a cellular telephone as display device 130, and has a keypad as input device 134. Computing device 110 is located within a cellular telephone and is coupled to the LCD display and keypad. Furthermore, the communications system 136 is a cellular transmission system used to communicate between the two communication devices 202 and 204, as described below.

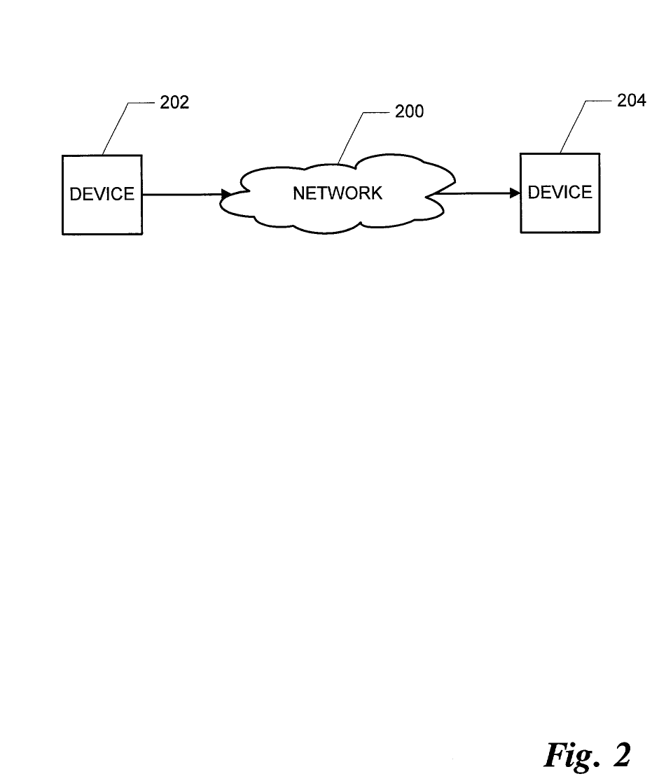

FIG. 2 is a simplified system diagram illustrating an exemplary system for the present invention. Although the present invention is primarily focused on the identification and selection of data objects, FIG. 2 is used to illustrate a typical application that can receive the benefits of the present invention. An originating communication device 202 includes one or more data objects that can be selected and transmitted. The data objects may include any of a variety of items such as MPEG files, MP3 files, phone numbers, phone lists, bit maps, JPEG files, or the like. Typically, the originating communication device 202 will provide an interface, such as a user or computer interface, through which particular data objects can be identified. For instance, in a particular embodiment, the originating communication device 202 includes a user interface over which a user can view and select, or mark one or more data objects that the user intends to transmit to a recipient communication device 204. Over this user interface, a data object, or a reference to a particular data object, is displayed and a transfer enable icon is used to indicate whether or not the data object can be transmitted.

Network 200 provides a communication channel between communication devices 202 and 204. This network is a cellular transmission system in the exemplary embodiment. However, network 200 may be any type of network capable of communicating data objects between two communication devices. Examples of suitable networks 200 include not only wireless, optical or wired networks, but also the Internet or local area networks.

It should be understood that although the present invention is described as marking data objects for transfer stored within memory of the originating communication device 202, the data object could also reside in an external device. The data object could then be accessed using any type of wired, wireless or optical interface, and transferred to the recipient communication device 204.

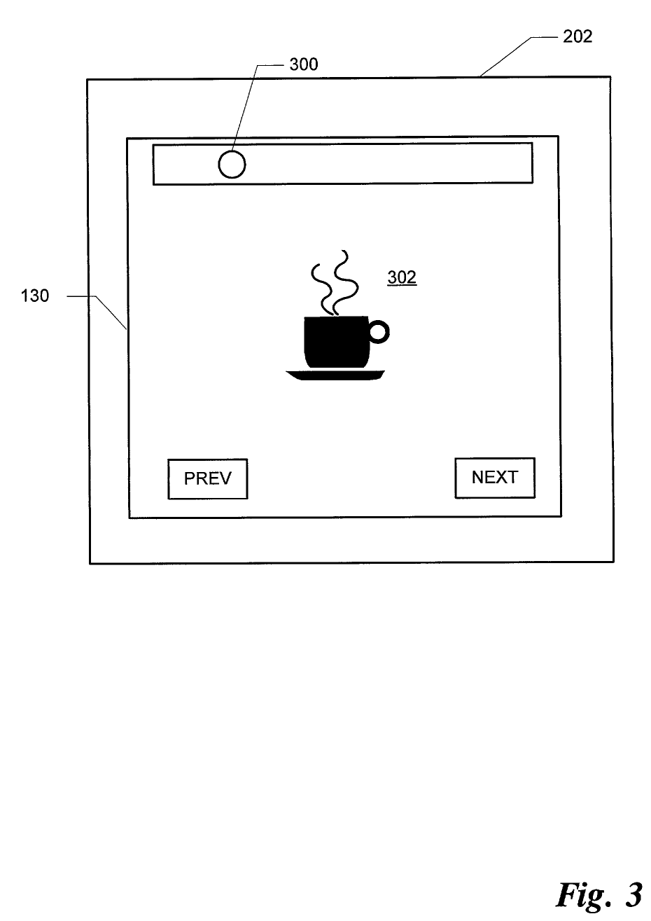

FIG. 3 is an illustration representing an exemplary display of a communication device embodying the present invention. In the exemplary embodiment, a display device 130 is affixed to a cellular telephone. The display device 130 may be an LCD display, a CRT monitor, LCD panel, LED panel, electro-luminescent panel, or any other display device. The display device includes an area 302 for displaying one or more data objects, which may be any type of data file, such as a text file, a sound file, or digital image. The data object may also be created by an external source, such as another electronic device or the Internet, or may be created internally such as a telephone number, one or more address book entries, or a voice memo message.

A transfer enable indicator 300 may be any kind of indication means, including but not limited to one or more LEDs, one or more pixels, or an icon. Furthermore, although the transfer enable indicator 300 is illustrated as residing on the display 130 of the communication device 202, in actuality it may appear elsewhere such as a dedicated button on the body of the communication device. The transfer enable indicator 300 may also be an intangible indication means such as a sound or light emitted from the device, or even the absence of a notification in a device, wherein notification is provided only when a file is incapable of transfer.

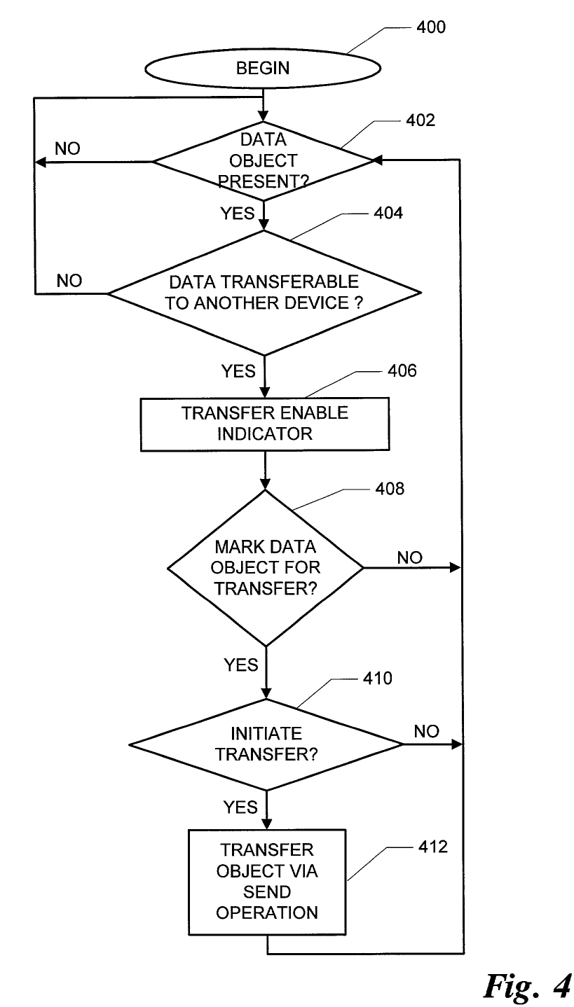

FIG. 4 is a flow diagram illustrating the data object mark and send operation of the present invention. Operation begins at step 400 when the communication device is powered on, and continues to run until the communication device is powered off or enters a mode in which the data object mark and send procedure is not available. For instance, the communication device may involve one or more modes of operation, such as voice memo mode or sleep mode. The operation described in FIG. 4 may operate in a subset of these modes, or during all of the modes, depending on the configuration of the communication device.

During operation, from time to time a data object may be presented on the display device. Presenting a data object on the display could involve displaying the data object, such as displaying the image of an image file. The name of the data object could also appear on the display of the communication device for the user to select, such as the file name of an image or sound file. Presenting a data object could also involve displaying a link to a reference of a data object.

If a data object is not present on the display, then the operation functionally enters a loop at step 402 until a data object is presented on the display. When a data object is present, the operation exits the loop at step 402, and determines if the data object can be transferred to another communication device at step 404. This determination requires examining the attributes of the data object to ascertain its pertinent characteristics, such as size, location, confidentiality, and file type. In addition, each data object may include a flag to indicate whether or not the data object is transferable. The data object is capable of transfer if pertinent characteristics provide for a transfer of the file to another communication device, given the memory and other restrictions of the originating communication device. If the data object is capable of being transferred to another communication device, the transfer enable indicator 300 is activated at step 406. After activating the transfer enable indicator 300, processing continues at step 408.

If the data object is not capable of being transferred at step 404, then processing continues at step 402 until another data object is presented on the user interface of the communication device 200. Once another data object is presented, processing returns to step 404. This cycle is repeated as long as the device is powered on or the current mode of operation allows it.

At step 408, the user may mark the data object as one to be transferred to another communication device. The present invention contemplates several methods to mark the data object for transfer. Exemplary methods of marking the data object include selecting an icon, pressing a dedicated button, pressing a function button, entering a sequence of buttons, actuating a key in a particular fashion, voice commands or the like. Regardless of the manner used to mark the data object, any means of marking may be used which ultimately informs the processing unit that the data object has been selected.

If at step 408, the user has marked the data object for transfer, then processing continues at step 410. Otherwise, processing continues at step 402, with the operation waiting for another data object to be present on the display. At step 410, the operation determines if the marked data object should be transferred immediately. This immediate transfer may take place automatically upon marking the data object, or may require prompting the user to take additional actions. For instance, in one embodiment, the data object will be transferred in response to actuating a particular key or key sequence. Other methods to initiate the transfer of the marked data object include, but are not limited to, voice activated commands, touch screen actuations, placing a call to another device, or the like. In another embodiment, the transfer may be actuated upon receiving an incoming call. In this embodiment, the device initiating the incoming call may be the recipient of the transferred data item.

At step 410, the user may also be required to enter a destination address, or other destination identifier. In one embodiment, the destination address may be the telephone number of a destination device. In another embodiment, the destination identifier may be a uniform resource locator (URL) address. In this embodiment, data objects can be sent to an electronic device or to a computer hosting web site. In another embodiment, the destination may be an email address.

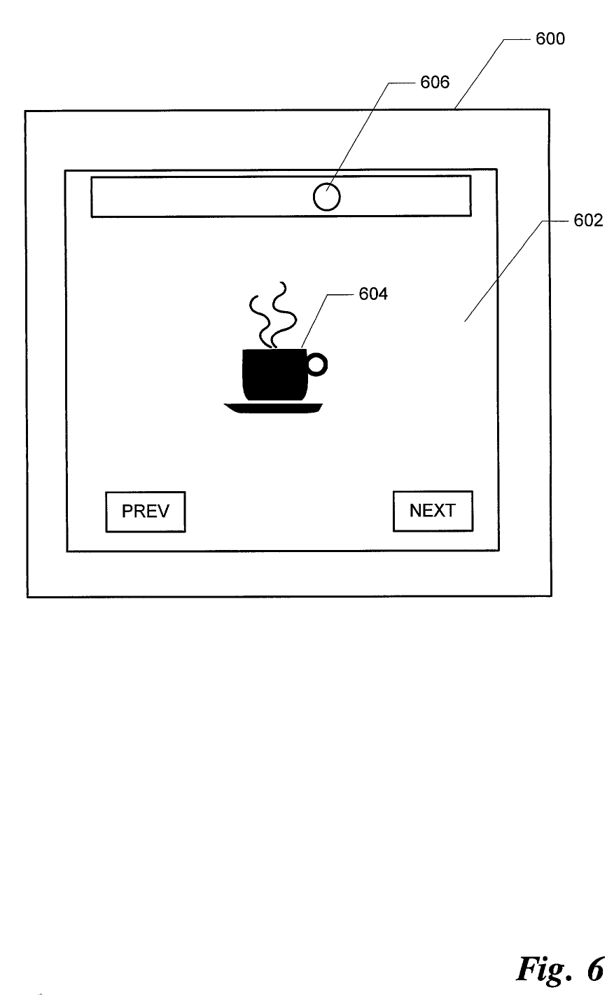

In another embodiment, when the data object is marked for transfer, a prompt for the destination identifier may be provided. The prompt could include a message on the display of the device, or include other techniques, such as audible prompts. In some embodiments, a default, or multiple default destination identifiers may be used to identify the destination for the marked objects. Embodiments involving destination identifiers may provide a field associated with the data object to indicate the transfer destination for the data object. If the device initiating the incoming call matches the field indicating the transfer destination, the data object is transferred to the device once the call is received. Alternatively, the operation may simply transfer the marked data object to the next incoming or outgoing call, regardless of the identity of the other device. If the data object is to be transferred immediately, the data object is transferred via a send operation at step 412, which is discussed in greater detail in FIG. 6. Once the data object is transferred at step 412, the operation returns to step 402 and waits until another data object is present on the user interface of the communication device to repeat the process.

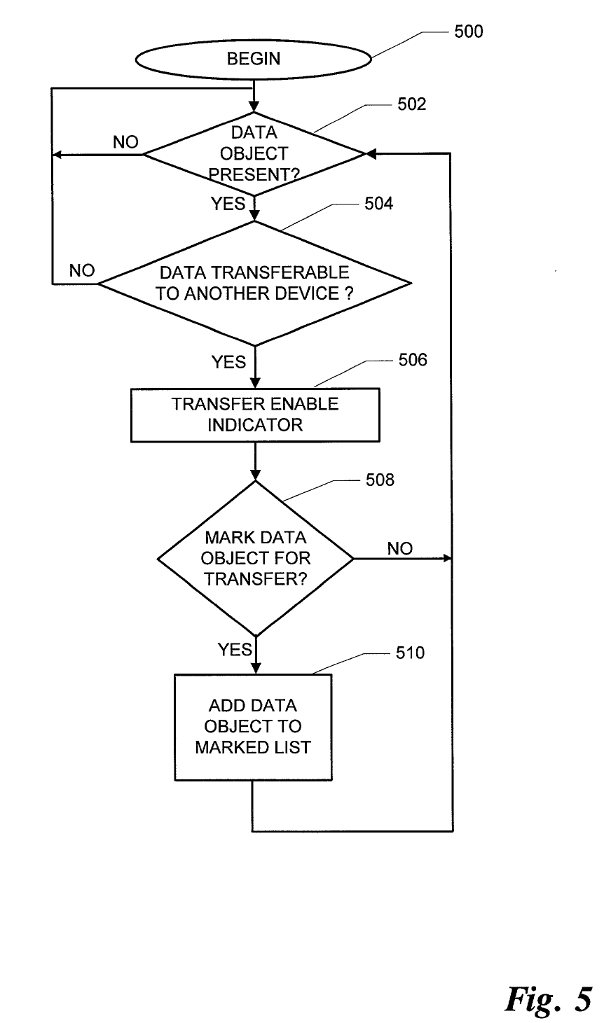

FIG. 5 is a flow diagram illustrating the steps involved in an exemplary embodiment of the data object mark and send operation of the present invention involving multiple marked data objects. In this embodiment, multiple data objects can be marked for transfer and then the transfer of these data objects can be initiated at a later time. Similar to the operation for marking a single data object, operation begins at step 500 when the communication device is powered on or enters an appropriate mode, and continues to run until the communication device is powered off or exits a mode in which the feature is enabled. During operation, from time to time a data object may be presented on the display device at decision block 502. As with the operation for marking a single data object, presenting a data object on the display could involve displaying the data object, such as displaying the image of an image file, or presenting the name of the data object for the user to select.

If a data object is being presented on the display 502, a determination is made as to whether the data object can be transferred to another communication device 504. If so, the transfer enable indicator 300 is activated at step 506. After activating the transfer enable indicator 300, processing continues at step 508 by determining if the data object is marked for transfer.

If the data object has been marked for transfer at step 508, then the operation adds the data object to a list of data objects marked for transfer. The list of data objects may appear on the user interface as a list of file identifiers associated with marked data objects, which the user may modify by selecting marked data objects to be removed from the marked data object list. Another embodiment may include a dedicated button on the body of the communication device, which presents the modifiable list of file identifiers associated with marked data objects on the user interface of the electronic device upon activation. Once presented, the list of marked data objects can be edited by the user selecting marked data objects for removal from the marked data object list. These data objects in the marked data object list may be of various types and sizes, and may also have different associated destinations. The data objects in the marked data objects list, if any remain after the list is modified by the user, are then transferred during the send operation which is discussed in greater detail in FIG. 6.

If the operation determines that the data object is not capable of being transferred at step 504, the processing returns to step 502 and waits until another data object is presented on the user interface of the communication device 200. Once another data object is presented, processing returns to step 404. This cycle is repeated as long as the device is powered on.

FIG. 6 is an illustration representing an exemplary display of the communication device embodying the present invention once the user has marked a data object for transfer. A marked object indicator 606 is presented on the display 602 of communication device 600 after the user has marked a data object 604. This marked object indicator may be any kind of indication means, including but not limited to one or more LEDs, one or more pixels, inverting the object, shading the display, an icon or some other means. The marked object indicator 606 is illustrated as residing on the display 602 of the communication device 600. However, a dedicated button on the body of the communication device 600 or an intangible indication means such as a sound or light emitted from the communication device 600 may also be used effectively as presenting the marked object indicator 606.

Overall, this invention will improve the utility of communication devices by activating a transfer enable indicator when a data object can be transferred to another communication device. Additionally, the invention will provide an simple method for users of communication devices to choose desired data objects for transfer. This invention will be useful because of the improved user interface it will provide for such communication devices, and the resulting ease of transferring a data object between communication devices.

What is claimed is:

1. A method of marking data objects on an electronic device to be transferred by the electronic device, the method comprising the steps of:
a) presenting a data object on a user interface of the electronic device;
b) applying a set of criteria to the data object to determine if the data object is capable of being transferred; and
c) providing an indicator if the data object is capable of being transferred by the electronic device.

2. The method of claim 1, wherein presenting a data object on the user interface of the electronic device comprises displaying the data object on a display of the electronic device.

3. The method of claim 1, wherein if the data object is capable of being transferred, further comprising the steps of:
d) allowing the data object to be selected for transfer; and
e) transferring the data object.

4. The method of claim 3, wherein the step of allowing the data object to be selected for transfer further comprises adding the data object to a modifiable list of data objects selected for transfer.

5. The method of claim 1, wherein the applying a set of criteria step comprises the step of retrieving one or more attributes of the data object and determining if the attributes exceed predetermined transfer limitations.

6. The method of claim 5, wherein the predetermined transfer limitations comprise file size limitations, confidentiality limitations, and file type limitations.

7. The method of claim 1, wherein the step of providing an indicator comprises presenting an icon on the user interface of the electronic device.

8. The method of claim 1, wherein the step of providing an indicator comprises sounding an auditory alert on the electronic device.

9. The method of claim 1, wherein the step of providing an indicator comprises illuminating a dedicated button on the electronic device.

10. A method of marking data objects on an electronic device to be transferred by the electronic device, the method comprising the steps of:
a) presenting a data object on a user interface of the electronic device;
b) applying a set of criteria to the data object to determine if the data object is capable of being transferred; and
c) providing an indicator if the data object is incapable of being transferred by the electronic device.

11. The method of claim 10, wherein presenting a data object on the user interface of the electronic device comprises displaying the data object on a display of the electronic device.

12. The method of claim 10, wherein if the data object is capable of being transferred, further comprising the steps of:
d) allowing the data object to be selected for transfer; and
e) transferring the data object.

13. The method of claim 12, wherein the step of allowing the data object to be selected for transfer further comprises adding the data object to a modifiable list of data objects selected for transfer.

14. The method of claim 10, wherein the applying a set of criteria step comprises the step of retrieving one or more attributes of the data object and determining if the attributes exceed predetermined transfer limitations.

15. The method of claim 14, wherein the predetermined transfer limitations comprise file size limitations, confidentiality limitations, and file type limitations.

16. The method of claim 10, wherein the step of providing an indicator comprises presenting an icon on the user interface of the electronic device.

17. The method of claim 10, wherein the step of providing an indicator comprises sounding an auditory alert on the electronic device.

18. The method of claim 10, wherein the step of providing an indicator comprises illuminating a dedicated button on the electronic device.

19. A method of marking a plurality of data objects on an electronic device for transfer, comprising the steps of:
a) presenting a first data object;
b) applying a set of criteria to the data object to determine if the first data object is capable of transfer;
c) providing an indicator if the first data object is capable of being transferred by the electronic device;
d) allowing user to select the first data object for transfer;
e) adding the selected data object to a list of data objects for transfer;
f) presenting a next data object; and
g) repeating steps b) through e) with said next data object.

20. The method of claim 19, wherein list of data objects selected for transfer may be edited before transfer by the electronic device.

21. The method of claim 19, wherein the applying a set of criteria step comprises the step of retrieving the attributes of said first data object and determining if the attributes exceed predetermined transfer limitations.

22. The method of claim 21, wherein the predetermined transfer limitations comprise file size limitations and file type limitations.

23. The method of claim 19, wherein indicating on the user interface if the first data object is capable of transfer by the electronic device step comprises presenting an icon on the user interface of the electronic device.

24. The method of claim 19, wherein the providing an indicator step comprises sounding an auditory alert on the electronic device.

25. The method of claim 19, wherein the providing an indicator step comprises illuminating a dedicated button on the electronic device.

26. An apparatus capable of transferring one or more data objects, the apparatus comprising:
a) a memory device for containing a program module and at least one data object;
b) a user interface; and
c) a processing unit coupled to the memory device and the user interface, the processing unit being operative in response to the instructions of the program module to:
i) present a data object on a user interface of the electronic device;
ii) apply a set of criteria to the data object to determine if the data object is capable of being transmitted; and
iii) provide an indicator if the data object is capable of being transmitted.

27. The apparatus of claim 26, wherein if the processing unit determines that a data object is capable of being transmitted, further being operative in response to the instructions of the program module to:
d) allow the data object to be selected for transmission over a communications medium; and
e) transmit the data object.

28. The apparatus of claim 26, wherein the apparatus is a cellular telephone.

29. The apparatus of claim 26, wherein the apparatus is a computer with a modem.

30. The apparatus of claim 26, wherein the apparatus is a hand held computer.

31. The apparatus of claim 26, wherein the apparatus is a telephone.

32. The apparatus of claim 26, wherein the communications medium is a wireless medium.

33. The apparatus of claim 26, wherein the communications medium is a data channel of a cellular transmission medium.

34. The apparatus of claim 26, wherein the communications medium is an optical medium.

35. The apparatus of claim 26, wherein the communications medium is a wired medium.
